(19) United States
(12) Patent Application Publication
(10) Pub. No.: US 2006/0038661 A1
(43) Pub. Date: Feb. 23, 2006

(54) Data transfer on a current supply line

(75) Inventors: Volker Reinhold, Herrenberg (DE); Daniel Widmann, Holzgerlingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/140,050

(22) Filed: May 31, 2005

(30) Foreign Application Priority Data
May 29, 2004 (DE) 102004026468.6-35

(51) Int. Cl. G05B 11/01

(52) U.S. Cl. 340/310.11

(57) ABSTRACT

A method of transmitting data between a first and a second device (2, 3) by way of a power supply line between the first and the second device (2, 3). The power supply and the data transmission take place alternately in a power supply time window (21) and in a data transmission time window (22). As a result of this measure, a separate data transmission line is not be necessary.

This application claims the priority of DE 102004026468.6-35, filed May 29, 2004, the disclosure of which is expressly incorporated by reference herein.

### BACKGROUND AND SUMMARY OF THE INVENTION

The invention relates to a method of transmitting data between a first and a second device by way of a power supply line between the first and the second device, and to a data transmission system having a first device which is connected by way of a power supply line with a second device and supplies the second device with power. The power supply line is used as the data transmission line.

Normally, different lines are used for the supply and the data transmission. It is frequently necessary to transmit information—for example, the status of an electrical consuming device, such as an electrical failure or defect—from an electrical consuming device to a control unit. This can take place, for example, by means of a current measurement in the control unit. However, in certain cases, a failure detection is not possible in certain cases, for example, in the case of lights with LEDs (light emitting diodes) because of the low consuming device current. In order to detect the status of such consuming devices, a data line could additionally be integrated in the loom of cables between the consuming device and the control unit, which would require the loom of cables and the cable plug would have to be changed.

From German Patent Document DE 92 13 495 U1, a measuring device is known for detecting and transmitting physical quantities to an analyzing unit. The measuring device is connected with an analyzing module by way of a two-wire power supply line. Additionally, by way of the two-wire power supply line, the electric energy supply and a digital data transmission between the measuring device and the analyzing module take place simultaneously. The simultaneous transmission of data and the power supply can occur only if the information is modulated on the power supply line.

It is an object of the present invention to provide a method and a data transmission system for transmitting information and data in a simple manner between two devices.

This object is achieved by means of a method of the initially mentioned type, by which the power supply and the data transmission takes place alternately in a power supply time window and in a data transmission time window. A time-related variation of the function of the available line as a supply line and data line therefore takes place. As a result of this measure, a separate data line can be avoided.

The advantage of the invention becomes clear, for example, in the case of the initially mentioned example of the use of lights with LEDs or of another electrical load. No new data line is required in order to monitor the condition of the load. The power supply line, which is already present, is used for the transmission of the load condition or other data assigned to this load. The power supply and the communication can therefore take place on the same line. The same loom of cables and the same plugs can be used as in the case of a solution, which uses no data transmission. An “upgrading” of existing systems is easily possible (for example, by means of suitable electronic devices and/or by means of suitable data processing programs in the first and/or second device) when, in addition to the power supply, a data transmission becomes necessary.

The power supply time window for the power supply and the data transmission time window for the data transmission are preferably defined by means of a pulse-type supply current. For this purpose, a pulse duration modulation is particularly suitable whose pulse edges limit the individual time windows.

According to one variation of the method, the data transmission time windows and the power supply time windows have a constant length over a certain time period (for example, when supplying a brake light with power during the braking operation of a motor vehicle). As a result, a synchronization of the data transmission can be achieved in a particularly simple manner. The receiver and the transmitter know at which points in time they are allowed to send and receive, or a receiver knows when signals are to be expected from a transmitter. The data communication is simplified in this manner. A correct data transmission in the data transmission time window is not ensured without a synchronization.

In a further development of the method, data transmission takes place in a unidirectional manner. In an alternative variant of the method, the data transmission takes place bidirectionally. The two devices can thereby communicate with one another. As a result, for example, not only can data be transmitted from a load to the device not assigned to the load but, inversely, data can also be transmitted from this latter device to the device assigned to the load.

In another variation of the method, a load is monitored in one of the two devices, and data assigned to this load, such as the status of the load, the status of certain components of the load, the temperature in the data transmission time windows, is transmitted. For example, one LED or several LEDs can be monitored as components of a motor vehicle light, and the condition of the LED or LEDs can be transmitted to a control unit, a control module, or the like.

In addition, the object is achieved by a data transmission system of the initially mentioned type, in the case of which the first device has a first transmitting and/or receiving unit, and the second device has a second transmitting and/or receiving unit. The first device has a current pulse device, and the second device is supplied with current in a pulsed manner. The current pulse device defines the power supply time windows and the data transmission time windows.

In particular, the second transmitting and/or receiving unit may be constructed as a data signal generating unit which, in the pauses between the current or voltage pulses, transmits data signals by way of the power supply line, and the first sending and/or receiving unit can be constructed as a data signal detecting unit.

It is particularly advantageous for the first transmitting and/or receiving unit to comprise a microprocessor and to control an electronic switch of the current pulse device for switching the power supply of the second device on and off. When the first transmitting and/or receiving unit also controls the current pulse device, the first transmitting and/or receiving unit will know at which intervals data are transmitted. For example, transmitted data are to be expected when the power supply of the second device is switched off by the electronic switch. In these pauses, data can be transmitted from the second to the first device or inversely. The microprocessor is advantageously connected to the power supply line, so that voltage changes during the pulse, pauses can be detected on the supply line. As a result of such voltage changes, information can be encoded and data can thereby be transmitted.

The second transmitting and/or receiving device advantageously includes a microprocessor, which is connected to the power supply line. In this manner, this microprocessor of the second device can detect at which intervals current signals are arriving, or the length of the pauses have between the current signals. In this manner, the microprocessor can synchronize the first transmitting and/or receiving unit with the second transmitting and/or receiving unit, so that data from the second transmitting and/or receiving unit is always transmitted at the correct points in time.

In another preferred embodiment of the invention, the microprocessor of the second transmitting and/or receiving unit controls two electronic switches with one switch being arranged in series with respect to a load, and the other switch being arranged parallel to a diode. In particular, the two switches are switched synchronously, with the first switch being controlled such that, for the transmission of a certain signal or logic level during the data transmission time window, the load is uncoupled from the power supply and the other switch being closed for the transmission of the signal, so that a direct connection is established between the microprocessor and the power supply line. In the case of a bidirectional data transmission, however, the above-mentioned first switch should continuously open and close in time with the pulse modulation, particularly the pulse width modulation. As a result, a rise in the load current is prevented when a high level is transmitted in the phase of the load current. When the load includes illumination (for example, LEDs), an undesirable flashing would otherwise take place.

It is particularly advantageous to arrange an energy accumulator, particularly a capacitor or an inductance, in the second device. By means of such an energy accumulator, the microprocessor can be supplied with voltage as long as the power supply to the second device is interrupted, that is, during a data transmission time window.

Other objects, advantages and novel features of the present invention will become apparent from the following detailed description of the invention when considered in conjunction with the accompanying drawings.

An embodiment is illustrated in a schematic view and will be explained in the following description.

### BRIEF DESCRIPTION OF THE DRAWINGS

FIG. 1 is a block diagram of a data transmission system;

FIG. 2 is a signal diagram for representing the method of operation of the data transmission system;

FIG. 3 is a signal diagram for representing the method of operation of the data transmission system in another embodiment;

FIG. 4 is an enlarged partial representation of the signal diagram in the area of a data transmission time window.

### DETAILED DESCRIPTION OF THE DRAWINGS

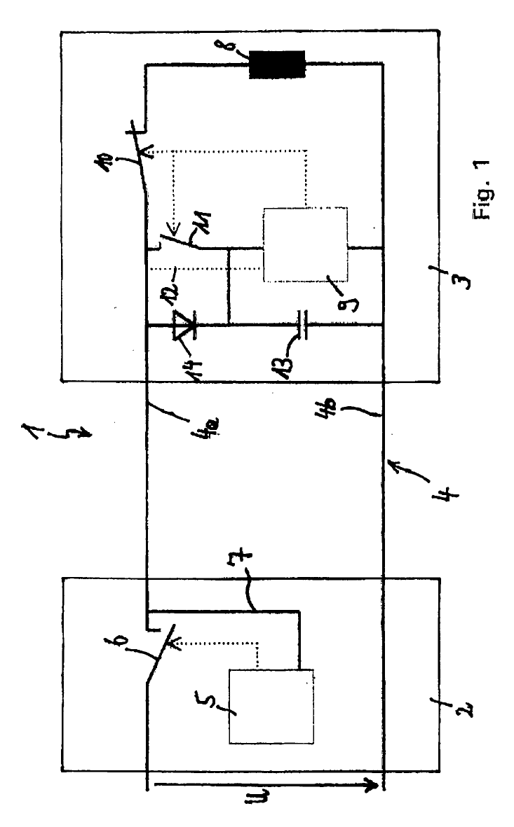

FIG. 1 illustrates a data transmission system 1 which include a first device 2 and a second device 3, which are mutually connected by means of a power supply line 4. The first device 2 is constructed as a control module and has a first transmitting and/or receiving unit 5, which is constructed as a microprocessor and acts as a data acquisition device. The first transmitting and/or receiving unit 5 controls an electronic switch 6, a supply voltage U being transmitted to the power supply line 4 when the electronic switch 6 is closed. The electronic switch 6, together with the voltage supply U, therefore forms a current pulse device. In addition, the first transmitting and/or receiving unit 5 is also connected by way of the line 7 with the power supply line 4, so that the voltage between the conductors 4a, 4b of the power supply line 4 can be detected. The second device 3 comprises an electric load 8 (such as one or more LEDs as the LED light). Furthermore, a second transmitting and/or receiving unit 9, constructed as a microprocessor, acts as a data generating device and controls a second electronic switch 10 and a third electronic switch 11. As indicated by the dotted line 12, the second transmitting and/or receiving unit 9 is connected with the supply line 4. It can thereby be detected in which timing the power supply takes place by way of the switch 6. Parallel to the second transmitting and/or receiving unit 9, an energy accumulator 13 is provided which is constructed as a capacitor and by way of which the second transmitting and/or receiving unit 9 is supplied with voltage when the switch 6 is opened; that is, the voltage supply is separated from the second device 3. The second transmitting and/or receiving unit 9 can monitor or check different functions and physical quantities of the load 8 (for example, status, operational failure, temperature) and, by means of the corresponding switch position of the switches 10, 11, transmit signals or data assigned to the load 8 by way of the power supply line 4 to the first device 2. A diode 14 is provided parallel to the switch 11.

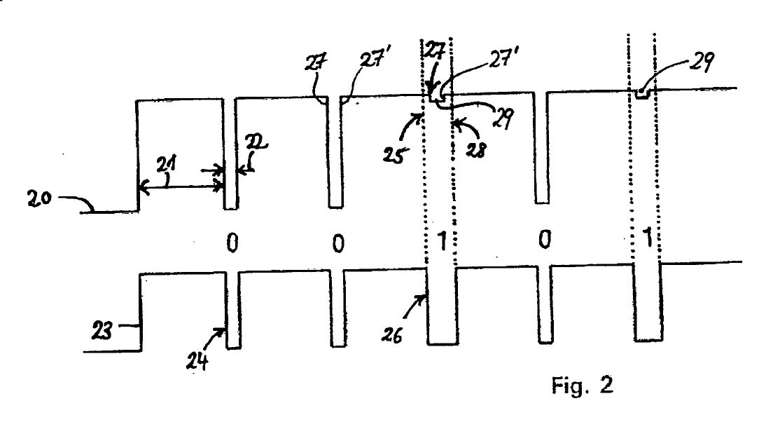

FIG. 2 illustrates the signal courses of the data transmission device 1. The curve 20 shows the voltage curve of the voltage applied between the conductors 4a, 4b, which is built up according to a pulse width modulation. During a power supply time window 21, that is, when the switch 6 is closed, the supply voltage U is applied to the power supply line 4 and thus to the second device 3. The switch 6 is opened during a data transmission time window 22. A load current 23 flows through the load 8 as long as the switch 6 is closed. When the switch 6 is opened, a current also does not flow through the load 8, so that the load current changes to 0 A at point 24. If, when the switch 6 is open, the voltage between the strip conductors 4a, 4b is at approximately 0 V, this means that the switches 10, 11 are in the position illustrated in FIG. 1. This means that the logic level 0 is transmitted during the data transmission time window 22. However, if a logic 1 is to be transmitted, the second transmitting and/or receiving unit 9 controls the switches 10, 11 for a short time before the switch opens 6, so that the switch 10 opens and the switches 11 closes. This takes place at location 25. As a result of the fact that the switch 10 is opened, the load current changes to 0 A at location 26. If the switch 6 is opened at location or pulse edge 27, only a slight voltage change occurs because of the closed switch 11 and of the capacitor 13 as well as the diode 14. This is detected by the first transmitting and/or receiving unit 5 and is equated with a logic 1. In this manner, different series of logic levels can be generated which can be decoded by the first transmitting and/or receiving unit 5 and by which, for example, the condition of the load 8 can be expressed. At location 28, the switch 10 is closed by the second transmitting and/or receiving unit 9 and the switch 11 is opened.

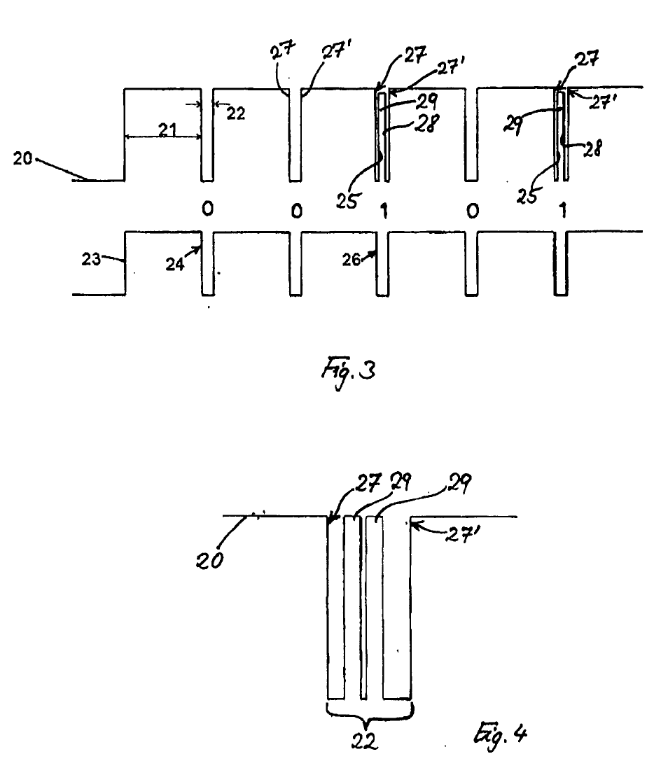

In another embodiment according to FIG. 3, the point in time of location 25, with respect to the time, is behind location 27, while the point in time of location 28, with respect to the time, is situated in front of a pulse edge 27′. This has the advantage that the pulse width modulation for the load 8, which takes place by means of switch 6 and can be recognized on the curve 20, remains the same. When LEDs represent the load, this reliably prevents an undesirable flickering.

Either a single data bit 29 (FIGS. 2 and 3) or several data bits (FIG. 4) can be transmitted in a data transmission time window 22.

The foregoing disclosure has been set forth merely to illustrate the invention and is not intended to be limiting, Since modifications of the disclosed embodiments incorporating the spirit and substance of the invention may occur to persons skilled in the art, the invention should be construed to include everything within the scope of the appended claims and equivalents thereof.

What is claimed is:

1. A method of transmitting data between a first and a second device by way of a power supply line between the first and the second device (2, 3), said method comprising:
providing power on said power supply line during a power supply time window; and
providing data transmission during a data transmission time window wherein said power supply window and said data transmission window alternate.

2. The method according to claim 1, wherein data transmission time windows and the power supply time windows are defined by the pulse edges of a pulse-width-modulated power supply.

3. The method according to claim 1, wherein the data transmission takes place in a unidirectional manner.

4. The method according to claim 1, wherein data transmission takes place in a bidirectional manner.

5. The method according to claim 1, wherein an electric load, which is supplied with the current, is assigned to one of the first and second device.

6. The method according to claim 5, wherein data assigned to the load are transmitted in the data transmission time windows.

7. A data transmission system comprising:
a first device connected to a first end of a power supply line,
a second device connected to a second end of said power supply line for receiving current, wherein the power supply line is used as a data transmission line, wherein the first device includes a first transmitting/receiving unit, wherein the second device includes a second transmitting/receiving unit, and wherein the first device includes a pulse width modulation current pulse device for supplying pulses to the second device.

8. The data transmission system according to claim 7, wherein the first transmitting/receiving unit comprises a microprocessor and controls an electronic switch of the current pulse device for switching the current pulse device.

9. The data transmission system according to claim 7, wherein the second transmitting/receiving unit device comprises a microprocessor connected to the power supply line.

10. The data transmission system according to claim 9, wherein the microprocessor of the second transmitting/receiving unit controls first and second electronic switches with said first switch arranged in series with a load, and said second switch arranged parallel with a diode.

11. The data transmission system according to claim 7, wherein one of a capacitor and an inductance is arranged in the second device.

12. A method of transmitting data between a first device and a second device comprising the steps of:
connecting said first device to said second device by a power supply line;
providing power on said power supply line during a power supply time window; and
providing data transmission on said power supply line in a data transmission time window, wherein a value of said data said transmission is a function of the relationship between the duration of the power supply time window and the data transmission time window.

13. The method according to claim 12, wherein data transmission time windows and power supply time windows are defined by a pulse edges of a pulse-width-modulated power supply.

14. A data transmission system comprising:
a transmitting/receiving unit controlling output of a pulse-width-modulated current;
a load circuit including a switching control device for controlling said output to define and first and second time window, wherein said first time window is a power supply time window and said second time window is a data transmission time window and wherein the value of said data transmission is a function of the relationship of the durations of the first and second time windows.

15. The data transmission system according to claim 14, wherein said transmitting/receiving unit includes a microprocessor and an electronic sewage force switching said power.

16. The data transmission system according to claim 15, wherein said load device includes a second microprocessor connected to said line.

17. The data transmission according to claim 16, wherein said second microprocessor controls first and second electronic switches with said first switch arranged in series with a load and the second switch arranged parallel with a diode.
